(19) United States
(12) Patent Application Publication
(10) Pub. No.: US 2025/0025773 A1
(43) Pub. Date: Jan. 23, 2025

(54) Dynamically Changing Button Indicia for a Game Controller

(71) Applicant: Backbone Labs, Inc., Vancouver, WA (US)

(72) Inventor: Ozhan Maker, San Diego, CA (US)

(73) Assignee: Backbone Labs, Inc., Vancouver, WA (US)

(21) Appl. No.: 18/734,411

(22) Filed: Jun. 5, 2024

Related U.S. Application Data
(63) Continuation of application No. 18/086,103, filed on Dec. 21, 2022, now Pat. No. 12,070,678.

(51) Int. Cl. A63F 13/24; A63F 13/92

(52) U.S. Cl. CPC A63F 13/24; A63F 13/92

(57) ABSTRACT

A gaming device that includes a handheld controller having a handle and a depressible button on the handle configured to receive user input. The depressible button includes a first marking layer including a first indicia, a first light source configured to illuminate the first indicia in the first marking layer, a second marking layer stacked with the first marking layer and including a second indicia, and a second light source configured to illuminate the second indicia in the second marking layer.

### TECHNICAL FIELD

The subject matter is related to an apparatus and methods for marking buttons on a gaming input device, and, more particularly, to an apparatus and methods for dynamically changing button indicia through illumination of various layers.

### BACKGROUND

Gaming input devices, such as handheld controllers, typically have a series of buttons for taking user input, where the separate buttons serve different functions. These buttons are typically marked—for example, with shapes, symbols, or letters—to designate each button's function. Most often, buttons are marked permanently in some way, through printing, etching, or other means. But individual buttons may have multiple functions. For instance, one button may be used to access a settings menu, and it may be further used to make selections within the settings menu. Accordingly, buttons on gaming input devices must sometimes be marked with more than one marking or must otherwise be able to indicate more than one function.

Some gaming input devices exist on the market that interface with mobile devices to simulate the traditional console experience. Such devices can mimic the experience, particularly the button and joystick configurations, of more than one console type and allow users to switch between modes of gameplay. To accomplish this, buttons on these devices must be capable of displaying more than one marking, allowing a user to read the markings and determine which marking is applicable for a particular gaming experience. Devices currently on the market permanently mark buttons with more than one function. For example, a button may be marked with both an “X” and an “A,” indicating to the user the available functions of that button.

But permanently marking buttons with more than one marking can be confusing to the user. Particularly in fast-paced gaming environments, a user may not immediately be able to determine the proper function of a button due to misreading or due simply to needing an extra moment to process which marking applies. The user may need “X” but not see an “X” quickly enough because of the presence of an “A.” Although the flexibility of switching between gaming modes is desirable, current gaming input devices do not offer the most user-friendly experience.

Configurations of the disclosed technology address shortcomings in the prior art.

### BRIEF DESCRIPTION OF THE DRAWINGS

FIG. 1 is a front view of an example gaming input device that may be used in configurations.

FIG. 2 is a front view of another example gaming input device that may be used in configurations.

FIG. 3 is a detail view of a handle of a gaming input device, such as the gaming input

device of either FIG. 1 or FIG. 2, also showing the dynamically changing buttons in an example third configuration where the buttons appear blank or dark.

FIG. 4 is a detail view of the handle of FIG. 3, showing the dynamically changing

buttons being illuminated in an example first configuration.

FIG. 5 is a detail view of the handle of FIG. 3, showing the dynamically changing

buttons being illuminated in an example second configuration.

FIG. 6 is a partial sectional view depicting an example layered structure for a

dynamically changing button.

FIG. 7 is a perspective view of the dynamically changing button of FIG. 6.

FIG. 8 is an exploded view of the dynamically changing button of FIG. 7.

FIG. 9 illustrates an alternative of the configuration shown in FIG. 8.

FIG. 10 is an example of a color wheel.

### DETAILED DESCRIPTION

As described herein, aspects are directed to dynamically changing button indicia for gaming input devices. Configurations of the disclosure include buttons that utilize multiple sources of light and a layered button structure to illuminate different indicia and thus display different indicia at the surface of the button. Accordingly, configurations of the disclosure limit the clutter of permanent markings on gaming input devices, limit confusion for users, and allow for flexibility between modes of gameplay or button function for various games.

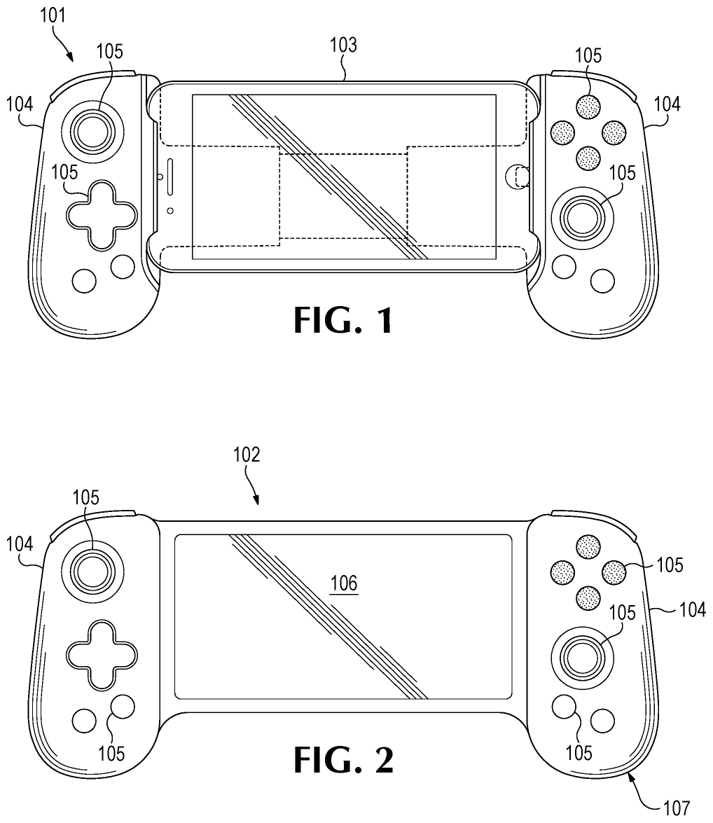

FIG. 1 depicts a front view of an example gaming input device 101 that may be used in configurations of the disclosed technology. As illustrated in FIG. 1, the gaming input device 101 interfaces with a mobile device 103, and the gaming input device 101 may be capable of replicating the console controller experiences of consoles like XBOX™ and PlayStation™ or otherwise serving as an input device for a variety of games to be played on the mobile device 103. For purposes of the disclosure, “mobile device” refers to a portable, handheld computing device, such as a smartphone, tablet, or other comparable mobile device. The gaming input device 101 may be, for example, the game controller for a mobile device as disclosed in patent U.S. Pat. No. 11,389,721. As illustrated in FIG. 1, the game controller 101 includes handles 104. Each handle 104 in the example configuration includes user-accessible, hardware interfaces 105, such as one or more of a button, an analog stick, a touchscreen, a touchpad, a knob, a slider, a switch, a wheel, a dial, a directional pad, or another such feature configured to accept touch inputs from a user's finger or a stylus. One or more of the user-accessible, hardware interfaces 105 may be dynamically changing buttons 100, as described more fully below.

FIG. 2 depicts a front view of another example gaming input device 102 that may be used in configurations of the disclosed technology. As with the gaming input device 101 of FIG. 1, the gaming input device 102 of FIG. 2 may be capable of replicating the console controller experiences of consoles like XBOX™ and PlayStation™ or otherwise serving as an input device for a variety of games to be played on the gaming input device 102. As illustrated in FIG. 2, the gaming input device 102 includes a display screen 106 integrated into a handheld game controller 107 and does not require interfacing with a user's mobile device 103. The gaming input device 102 further includes handles 104. Each handle 104 in the example configuration includes user-accessible, hardware interfaces 105, such as one or more of a button, an analog stick, a touchscreen, a touchpad, a knob, a slider, a switch, a wheel, a dial, a directional pad, or another such feature configured to accept touch inputs from a user's finger or a stylus. One or more of the user-accessible, hardware interfaces 105 may be dynamically changing buttons 100, as described more fully below.

For purposes of the discussion that follows, references to a gaming input device could refer to the gaming input device 101 of FIG. 1, the gaming input device 102 of FIG. 2, or any other gaming input device having physical buttons. Also, as used in this disclosure, “indicia” means the shapes, symbols, letters, or other markings on a button and that designate the button's function.

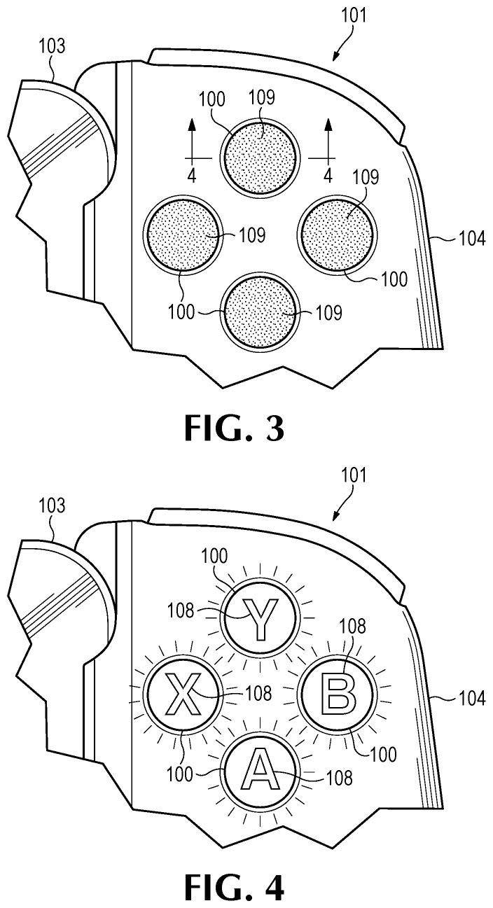

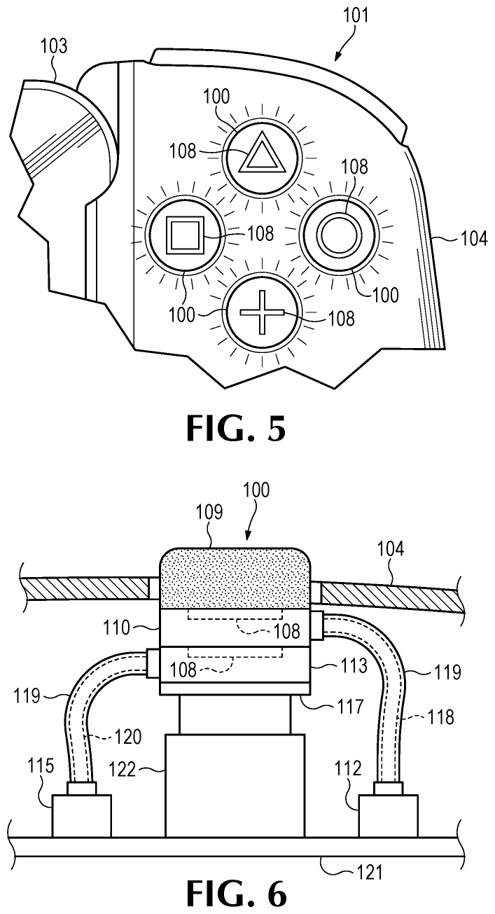

FIG. 3 is a detail view of a handle 104 of a gaming input device. As illustrated in FIG. 3, the handle 104 may include one or more dynamically changing buttons 100. The dynamically changing buttons 100 display different indicia 108 to match the appropriate gameplay environment. For example, as illustrated in FIG. 4, the dynamically changing buttons 100 may follow a first configuration and display indicia 108 associated with those on XBOX™ controllers, without displaying other indicia. In addition, as illustrated in FIG. 5, the same dynamically changing buttons 100 may instead follow a second configuration and display indicia 108 associated with those on PlayStation™ controllers. The references to indicia associated with those on XBOX™ controllers and to indicia associated with those on XBOX™ controllers are used as examples only, as they would be familiar to most game players. The indicia 108, however, are not limited to those configurations and could include any indicia necessary or useful for gameplay or other activities with the gaming input device.

In configurations, when the gaming input device is not in use, or when a mode of use has not been selected, the dynamically changing buttons 100 appear blank or dark, as illustrated in FIG. 3, because they are not internally illuminated in this third configuration. As discussed in further detail below, the dynamically changing buttons 100 thus display a dark background without visible indicia 108.

In configurations, each of the dynamically changing buttons 100 is controlled individually. In such versions, then, the buttons 100 do not need to all be in the same configuration. Hence, for example, some buttons 100 could be in the first configuration, some could be in the second configuration, and some could be in the third configuration. In other configurations, all of the dynamically changing buttons 100 are in the same configuration.

Accordingly, in versions, the gaming input device may have dynamically changing buttons 100 that are configured to change between an “off” configuration in which the dynamically changing buttons 100 are not internally illuminated and at least one “on” configuration in which the dynamically changing buttons 100 are internally illuminated. In some example versions, there may be only one marking layer, such as the first marking layer 110, and one light source, such as the first light source 112. In other example versions, there may be more than one marking layer, such as the first marking layer 110 and the second marking layer 113, and more than one light source, such as the first light source 112 and the second light source 115. In other example versions, the gaming input device may have dynamically changing buttons 100 that are configured to change between at least two different “on” configurations in which the dynamically changing buttons 100 are internally illuminated, in which the “on” configurations are different because different indicia 108 are illuminated or because one or more of the indicia 108 that are illuminated in one of the “on” configurations is not illuminated in the other “on” configuration. These example versions may or may not include the top casing 109 (described below) in all versions of such configurations. Also, the dynamically changing buttons 100 may be controlled individually or all together in these example versions.

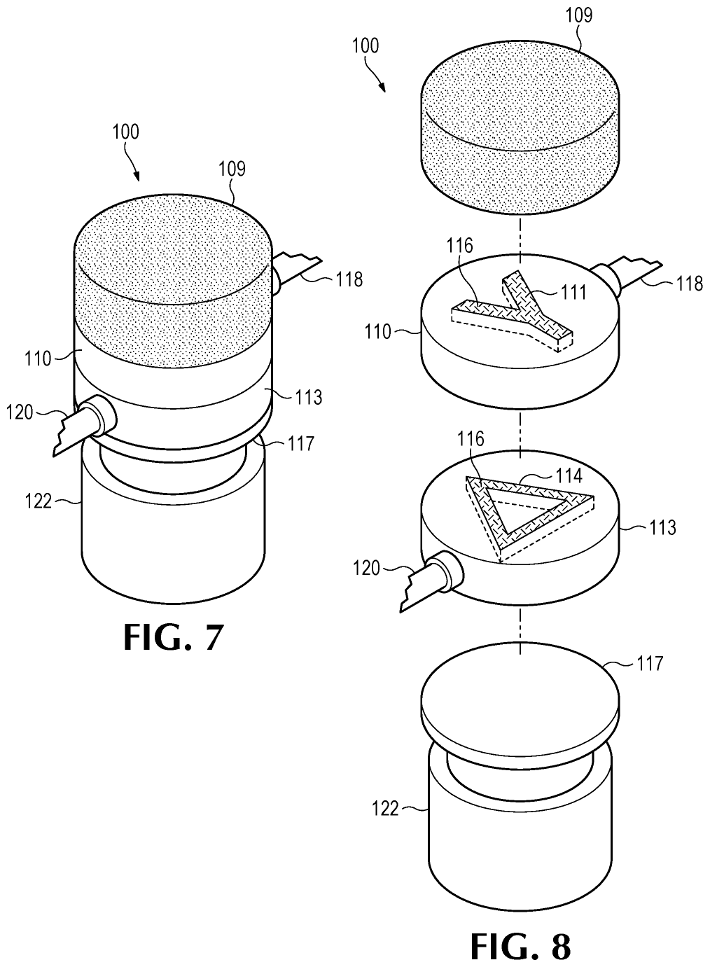

FIG. 6 depicts an example of a layered structure for the dynamically changing buttons 100, according to example configurations. FIG. 7 is a perspective view of the dynamically changing button of FIG. 6, and FIG. 8 is an exploded view of the dynamically changing button of FIG. 7. As illustrated in FIGS. 6-8, the dynamically changing buttons 100 may include a top casing 109. The top casing 109 is semi-transparent and may be tinted to give the dynamically changing buttons 100 a dark, smoky appearance when the indicia 108 are not internally illuminated, while allowing light to pass through and display the indicia 108 when the indicia 108 are internally illuminated. In the illustrated configuration, below the top casing 109 is a first marking layer 110 with a first indicia 111. The first marking layer 110 receives light from a first light source 112, as described further below, illuminating the first indicia 111 and allowing the first indicia 111 to be displayed through the top casing 109 and thus displayed to the user. In the illustrated configuration, below the first marking layer 110 is a second marking layer 113, which includes a second indicia 114. The second marking layer 113 receives light from a second light source 115, which is separate from the first light source 112.

In versions, the first light source 112 and the second light source 115 may emit light that is colored, meaning that the emitted light is not white.

The first marking layer 110 and the second marking layer 113 are transparent, allowing light to shine through, but each is tinted with a color corresponding to its respective light source. In other words, the tinting is substantially the same color as the light emitted from the respective light source. As used in this context, “substantially the same color” means that the two colors are closely situated to each other in a defined color space. An example of a standard color space is the Adobe RGB (1998), or opRGB, color space, which is also defined by International Electrotechnical Commission standard IEC 61966-2-5:1999. Color spaces often use the CIE xy chromaticity diagram, derived from experiments performed by the International Commission on Illumination, to describe the color space by referring to x- and y-coordinates on the CIE xy chromaticity diagram. Hence, for example, the primary color blue may be described as have an x-coordinate of 0.15 and a y-coordinate of 0.06 on the CIE xy chromaticity diagram. Accordingly, two colors may be “substantially the same color” as used in this disclosure if the x-coordinate and the y-coordinate are each within 0.2 of the respective coordinate of the two colors. Hence, using the example of the primary color blue having an x-coordinate of 0.15 and a y-coordinate of 0.06, a substantially similar color would have (i) an x-coordinate between 0.0 and 0.35, and (ii) a y-coordinate between 0.0 and 0.26. As another example, the primary color green may have an x-coordinate of 0.21 and a y-coordinate of 0.71 on the CIE xy chromaticity diagram. In that example, a substantially similar color would have (i) an x-coordinate between 0.01 and 0.41, and (ii) a y-coordinate between 0.51 and 0.91. In reality, some of these example values would fall outside of the visible spectrum. Hence, the actual boundaries of what is “substantially the same color” would be further limited to colors within the visible spectrum.

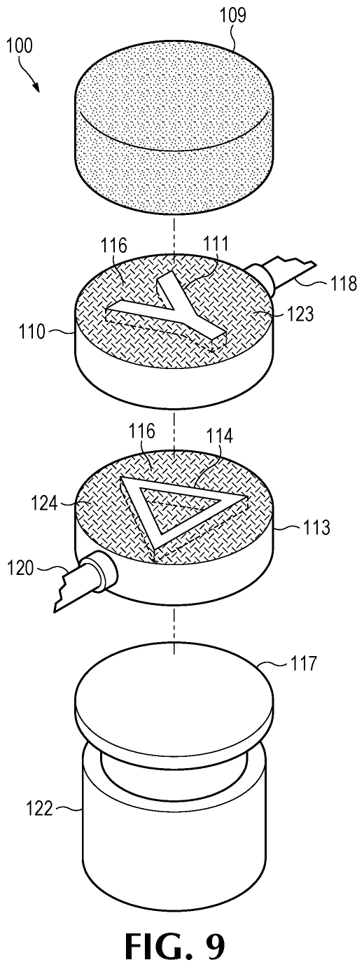

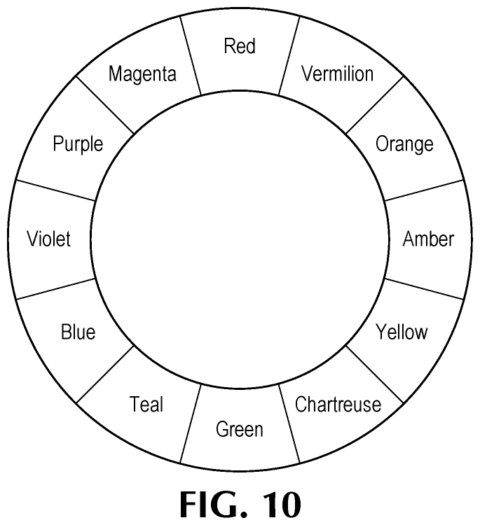

As such, the dynamically changing buttons 100 will illuminate either the first marking layer 110 or second marking layer 113 and display either the first indicia 111 or the second indicia 114 to the user. Each of the first marking layer 110 and the second marking layer 113 may also include texturing or etching 116 for scattering light from the respective light source to make the indicia 108 more visible. The texturing 116 may be, for example, frosting on the marking layer. Specifically, the texturing 116 is configured to redirect light from the respective light source toward the top casing 109. In configurations, the texturing 116 is configured to concentrate light rays on the indicia of the respective marking layer by allowing the light emitted from the respective light source to pass through transparent (non-textured or -etched) portions but break and reflect from the textured or etched portions. While FIG. 8 illustrates the texturing 116 as coinciding with the indicia, in configurations the texturing 116 may instead or also coincide with the surface of the marking layer surrounding the indicia. Accordingly, FIG. 9 shows an example of texturing 116 on the top surface 123 of the first marking layer 110 and on the top surface 124 of the second marking layer 113. As noted, the texturing 116 may also be on both the top surface and the indicia.

As illustrated, the dynamically changing buttons 100 also include a base layer 117, which may be made of a light-colored, substantially opaque material in example configurations. As used in this context, “substantially opaque” means largely or essentially impenetrable to light, without requiring perfect barricade to all light. The light-colored material may be, for example, white, at least on a surface of the base layer 117 facing the marking layers. This light, substantially opaque material allows for uniform distribution of the light sources in the first marking layer 110 and the second marking layer 113, contributing to the evenness of the first indicia 111 and the second indicia 114 at the surface by reflecting toward the top casing 109 light that might otherwise be absorbed by a darker-colored base layer 117. In configurations, the light-colored material may be a light shade of grey. As used in this context, if 0% is pure white and 100% is pure black, the light shade of grey may be 10% or less.

As illustrated, the dynamically changing buttons 100 also include a button base 122. The button base 122 couples the dynamically changing buttons 100 to the printed circuit board 121. The button base 122 may also include a spring mechanism, such as a compression spring, to allow the dynamically changing buttons 100 to be depressed by the user, such as during typical gameplay.

As noted above, the dynamically changing buttons 100 utilize multiple light sources to accomplish illuminating different indicia 108 at different times. With reference to the example configuration illustrated in FIG. 6, the first marking layer 110 is connected to a first light pipe 118. The first light pipe 118 is connected to a first light source 112 and conveys light from the first light source 112 to the first marking layer 110 to illuminate the first indicia 111. The first light pipe 118 is surrounded by a substantially opaque material 119 to help prevent leakage of light through the first light pipe 118 and to help increase the amount of light reaching the first indicia 111. The opaque material 119 also reduces the amount of light from the first light pipe 118 that may leak to the second indicia 114 and illuminate the second indicia 114 when not desired. When the light from the first light source 112 illuminates the first indicia 111, the first indicia 111 is visible to the user through the top casing 109, without displaying the second indicia 114. Similarly, when the second indicia 114 is needed instead of the first indicia 111, a second light source 115 may send light through a second light pipe 120 to the second marking layer 113 and illuminate the second indicia 114. The second light pipe 120 is likewise surrounded by a substantially opaque material 119. Each of the first light source 112 and the second light source 115 may be, for example, coupled to a printed circuit board 121 within the handle 104.

In sum, alternating between modes of gameplay involves alternating between the first light source 112 and the second light source 115, which in turn leads to the illumination of either the first indicia 111 or the second indicia 114 from the perspective of the user. Illumination by light sources within the handle 104, such as the first light source 112 and the second light source 115, is what is meant by being “internally illuminated” in this disclosure, contrasted with external illumination coming from light sources outside of the game controller.

As mentioned, in configurations of the disclosure, each of the first marking layer 110 and the second marking layer 113 is transparent but tinted with a color corresponding to each of the first light source 112 and the second light source 115. In configurations, the colors of the tinting and of the first light source 112 and the second light source 115 are selected to be complementary colors, meaning colors that are on opposite sides of a standard color wheel (e.g., blue and orange, green and red, yellow and purple). An example of a standard color wheel is provided in FIG. 10. Such complementary colors, when mixed, tend to cancel each other out by producing a grayscale color. When the colors are selected in this way, the tinting of the first marking layer 110 tends to reinforce light emitted from the first light source 112 and to diminish any light leaking through from the second marking layer 113 and its opposite tinting. Likewise, the second marking layer 113 tends to reinforce light emitted from the second light source 115 and to diminish any light leaking through from the first marking layer 110 and its opposite tinting. Accordingly, such color selection may enhance the visibility of one of the indicia 108 (for example, the first indicia 111) and limit any potential leak-through of the other of the indicia 108 (for example, the second indicia 114).

In configurations, the colors of the tinting and of the first light source 112 and the second light source 115 are selected to be near-complementary colors, meaning colors that are adjacent to the color on the opposite side of a standard color wheel. With reference to the example color wheel in FIG. 10, the near-complementary colors of green would be magenta and vermilion. Similarly, the near-complimentary colors of blue would be vermilion and amber. In the same way, the near-complimentary colors of violet would be orange and yellow.

Hence, for example, one of the first light source 112 or the second light source 115 may emit light that is blue, while the other of the first light source 112 or the second light source 115 emits light that is orange. As another example, one of the first light source 112 or the second light source 115 may emit light that is green, while the other of the first light source 112 or the second light source 115 emits light that is purple. As yet another example, one of the first light source 112 or the second light source 115 may emit light that is yellow, while the other of the first light source 112 or the second light source 115 emits light that is purple. As still another example, one of the first light source 112 or the second light source 115 may emit light that is red, while the other of the first light source 112 or the second light source 115 emits light that is green.

Even so, this disclosure does not necessarily require selection of complementary or near-complementary colors on a color wheel and should not be read to limit color selection in those ways.

As described above, in embodiments the dynamically changing buttons 100 may display indicia reflecting a single mode of gameplay at a time, such as XBOX™ indicia, when a user is engaged in a game. All the while, the dynamically changing buttons 100 maintain the ability to switch to a different set of indicia, such as PlayStation™ indicia, without displaying any extra and potentially confusing markings to the user. Nonetheless, configurations of the disclosure may allow both marking layers to be illuminated simultaneously.

While described above with regard to buttons, the disclosed technology and concepts can also be applied to other types of user-accessible, hardware interfaces 105, including knobs, sliders, switches, dials, directional pads, and other such features configured to accept touch inputs from a user's finger or a stylus and that include indicia.

Furthermore, the disclosed technology and concepts can also be applied to other types of user-accessible, hardware interfaces that are not components of gaming devices. Hence, the disclosed technology and concepts can be used on other user-accessible, hardware interfaces—such as buttons, knobs, sliders, switches, dials, directional pads, and other such features configured to accept touch inputs from a user's finger or a stylus—where there would be a benefit to displaying different indicia on the user-accessible, hardware interface at different times.

### EXAMPLES

Illustrative examples of the disclosed technologies are provided below. A particular configuration of the technologies may include one or more, and any combination of, the examples described below.

Example 1 includes a gaming device, comprising a handheld controller including a handle, and a depressible button on the handle configured to receive user input, the depressible button comprising: a first marking layer including a first indicia; a first light source configured to illuminate the first indicia in the first marking layer; a second marking layer stacked with the first marking layer and including a second indicia; and a second light source configured to illuminate the second indicia in the second marking layer.

Example 2 includes the gaming device of Example 1, in which the depressible button further comprises a top casing, the first marking layer being between the top casing and the second marking layer, the top casing configured to allow the first indicia to be visible to a user through the top casing when the first indicia is illuminated by the first light source, the top casing further configured to allow the second indicia to be visible to the user through the top casing when the second indicia is illuminated by the second light source.

Example 3 includes the gaming device of Example 2, in which the top casing has a smoky tint.

Example 4 includes the gaming device of any of Examples 1-3, in which the depressible button further comprises a substantially opaque base layer, the second marking layer being between the base layer and the first marking layer.

Example 5 includes the gaming device of Example 4, in which the base layer is white.

Example 6 includes the gaming device of Example 4, in which the base layer is a light shade of grey.

Example 7 includes the gaming device of any of Examples 1-6, in which the first light source is configured to illuminate the first indicia in the first marking layer in an “on” status of the first light source and to not illuminate the first indicia in the first marking layer in an “off” status of the first light source, in which the second light source is configured to illuminate the second indicia in the second marking layer in an “on” status of the second light source and to not illuminate the second indicia in the second marking layer in an “off” status of the second light source, in which the first light source is configured to be in the “off” status of the first light source when the second light source is in the “on” status of the second light source, and in which the second light source is configured to be in the “off” status of the second light source when the first light source is in the “on” status of the first light source.

Example 8 includes the gaming device of any of Examples 1-7, in which the first light source emits light that is colored, and in which the first marking layer is tinted in a first-marking-layer color that is substantially the same color as the light emitted from the first light source.

Example 9 includes the gaming device of any of Examples 1-8, in which the second light source emits light that is colored, and in which the second marking layer is tinted in a second-marking-layer color that is substantially the same color as the light emitted from the second light source.

Example 10 includes the gaming device of Example 9, in which the first-marking-layer color and the second-marking-layer color are complementary colors.

Example 11 includes the gaming device of Example 9, in which one of the first light source or the second light source emits light that is colored blue, and the other of the first light source or the second light source emits light that is colored orange.

Example 12 includes the gaming device of Example 9, in which one of the first light source or the second light source emits light that is colored green, and the other of the first light source or the second light source emits light that is colored purple.

Example 13 includes the gaming device of Example 9, in which one of the first light source or the second light source emits light that is colored yellow, and the other of the first light source or the second light source emits light that is colored purple.

Example 14 includes the gaming device of Example 9, in which one of the first light source or the second light source emits light that is colored red, and the other of the first light source or the second light source emits light that is colored green.

Example 15 includes the gaming device of any of Examples 1-14, in which the first marking layer includes texturing configured to scatter light emitted by the first light source.

Example 16 includes the gaming device of any of Examples 1-15, in which the second marking layer includes texturing configured to scatter light emitted by the second light source.

Example 17 includes the gaming device of any of Examples 1-16, in which the depressible button further comprises: a first light pipe configured to convey light emitted by the first light source to the first marking layer; and a second light pipe configured to convey light emitted by the second light source to the second marking layer.

Example 18 includes a depressible button for a gaming device, the depressible button comprising: a first marking layer including a first indicia; a first light source configured to illuminate the first indicia in the first marking layer; a second marking layer stacked with the first marking layer and including a second indicia; and a second light source configured to illuminate the second indicia in the second marking layer.

Example 19 includes the depressible button of Example 18, further comprising a top casing, the first marking layer being between the top casing and the second marking layer, the top casing configured to allow the first indicia to be visible to a user through the top casing when the first indicia is illuminated by the first light source, the top casing further configured to allow the second indicia to be visible to the user through the top casing when the second indicia is illuminated by the second light source.

Example 20 includes the depressible button of Example 19, in which the top casing has a smoky tint.

Example 21 includes the depressible button of any of Examples 18-20, further comprising a substantially opaque base layer, the second marking layer being between the base layer and the first marking layer.

Example 22 includes the depressible button of Example 21, in which the base layer is white.

Example 23 includes the depressible button of Example 21, in which the base layer is a light shade of grey.

Example 24 includes the depressible button of any of Examples 18-23, in which the first light source is configured to illuminate the first indicia in the first marking layer in an “on” status of the first light source and to not illuminate the first indicia in the first marking layer in an “off” status of the first light source, in which the second light source is configured to illuminate the second indicia in the second marking layer in an “on” status of the second light source and to not illuminate the second indicia in the second marking layer in an “off” status of the second light source, in which the first light source is configured to be in the “off” status of the first light source when the second light source is in the “on” status of the second light source, and in which the second light source is configured to be in the “off” status of the second light source when the first light source is in the “on” status of the first light source.

Example 25 includes the depressible button of any of Examples 18-24, in which the first light source is configured to emit light that is colored, and in which the first marking layer is tinted in a first-marking-layer color that is substantially the same color as the light emitted from the first light source.

Example 26 includes the depressible button of any of Examples 18-25, in which the second light source is configured to emit light that is colored, and in which the second marking layer is tinted in a second-marking-layer color that is substantially the same color as the light emitted from the second light source.

Example 27 includes the depressible button of Example 26, in which the first-marking-layer color and the second-marking-layer color are complementary colors.

Example 28 includes the depressible button of any of Examples 18-27, in which the first marking layer includes texturing configured to scatter light emitted by the first light source.

Example 29 includes the depressible button of any of Examples 18-28, in which the second marking layer includes texturing configured to scatter light emitted by the second light source.

Example 30 includes the depressible button of any of Examples 18-29, further comprising: a first light pipe configured to convey light emitted by the first light source to the first marking layer; and a second light pipe configured to convey light emitted by the second light source to the second marking layer.

Example 31 includes a user-accessible, hardware interface configured to accept touch inputs, the hardware interface comprising: a first marking layer including a first indicia; a first light source configured to illuminate the first indicia in the first marking layer; a second marking layer stacked with the first marking layer and including a second indicia; and a second light source configured to illuminate the second indicia in the second marking layer.

Example 32 includes the hardware interface of Example 31, further comprising a top casing, the first marking layer being between the top casing and the second marking layer, the top casing configured to allow the first indicia to be visible to a user through the top casing when the first indicia is illuminated by the first light source, the top casing further configured to allow the second indicia to be visible to the user through the top casing when the second indicia is illuminated by the second light source.

Example 33 includes the hardware interface of any of Examples 31-32, further comprising a substantially opaque base layer, the second marking layer being between the base layer and the first marking layer.

Example 34 includes the hardware interface of any of Examples 31-33, in which the first light source is configured to emit light that is colored, and in which the first marking layer is tinted in a first-marking-layer color that is substantially the same color as the light emitted from the first light source.

Example 35 includes the hardware interface of any of Examples 31-34, in which the second light source is configured to emit light that is colored, and in which the second marking layer is tinted in a second-marking-layer color that is substantially the same color as the light emitted from the second light source.

Example 36 includes the hardware interface of Example 35, in which the first-marking-layer color and the second-marking-layer color are complementary colors.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Although specific example configurations have been described for purposes of illustration, it will be understood that various modifications may be made without departing from the spirit and scope of the disclosure.

1-30. (canceled)

31. A handheld gaming controller comprising:
a handle; and
a user input device on the handle, wherein the user input device comprises:
first indicia in a first marking layer indicating a first function of the user input device for a first game; and
second indicia in a second marking layer indicating a second function of the user input device for a second game, wherein the second game is different from the first game;
a first light source;
a first channel configured to convey light emitted by the first light source to the first marking layer to illuminate the first indicia;
a second light source; and
a second channel configured to convey light emitted by the second light source to the second marking layer to illuminate the second indicia;
wherein:
the first light source is configured to be selectively activated in response to the handheld gaming device being configured for the first game; and
the second light source is configured to be selectively activated in response to the handheld gaming device being configured for the second game.

32. The handheld gaming controller of claim 31, wherein the user input device comprises a button, an analog stick, a touchscreen, a touch pad, a knob, a slider, a switch, a wheel, a dial, or a directional pad.

33. The handheld gaming controller of claim 31, wherein the user input device further comprises a top casing, the first marking layer being between the top casing and the second marking layer, the top casing configured to allow the first indicia to be visible to a user through the top casing when the first indicia is illuminated by the first light source, the top casing further configured to allow the second indicia to be visible to the user through the top casing when the second indicia is illuminated by the second light source.

34. The handheld gaming controller of claim 31, wherein the user input device further comprises a substantially opaque base layer, the second marking layer being between the base layer and the first marking layer.

35. The handheld gaming controller of claim 31, wherein:
the first light source is configured to illuminate the first indicia in the first marking layer in an “on” status of the first light source and to not illuminate the first indicia in the first marking layer in an “off” status of the first light source;
the second light source is configured to illuminate the second indicia in the second marking layer in an “on” status of the second light source and to not illuminate the second indicia in the second marking layer in an “off” status of the second light source;
the first light source is configured to be in the “off” status of the first light source when the second light source is in the “on” status of the second light source; and
the second light source is configured to be in the “off” status of the second light source when the first light source is in the “on” status of the first light source.

36. The handheld gaming controller of claim 31, wherein the first light source emits light that is colored, and wherein the first marking layer is tinted in a first-marking-layer color that is substantially the same color as the light emitted from the first light source.

37. The handheld gaming controller of claim 31, wherein the first marking layer includes texturing configured to scatter light emitted by the first light source.

38. A handheld gaming controller comprising:
a handle; and
a user input device on the handle, wherein the user input device comprises:
first indicia in a first marking layer indicating a first function of the user input device for a first mode of gameplay; and
second indicia in a second marking layer indicating a second function of the user input device for a second mode of gameplay, wherein the second mode of gameplay is different from the first mode of gameplay;
a first light source;
a first channel configured to convey light emitted by the first light source to the first marking layer to illuminate the first indicia;
a second light source; and
a second channel configured to convey light emitted by the second light source to the second marking layer to illuminate the second indicia;
wherein:
the first light source is configured to be selectively activated in response to the handheld gaming device being configured for the first mode of gameplay; and
the second light source is configured to be selectively activated in response to the handheld gaming device being configured for the second mode of gameplay.

39. The handheld gaming controller of claim 38, wherein the user input device comprises a button, an analog stick, a touchscreen, a touch pad, a knob, a slider, a switch, a wheel, a dial, or a directional pad.

40. The handheld gaming controller of claim 38, wherein the user input device further comprises a top casing, the first marking layer being between the top casing and the second marking layer, the top casing configured to allow the first indicia to be visible to a user through the top casing when the first indicia is illuminated by the first light source, the top casing further configured to allow the second indicia to be visible to the user through the top casing when the second indicia is illuminated by the second light source.

41. The handheld gaming controller of claim 38, wherein the user input device further comprises a substantially opaque base layer, the second marking layer being between the base layer and the first marking layer.

42. The handheld gaming controller of claim 38, wherein:
the first light source is configured to illuminate the first indicia in the first marking layer in an “on” status of the first light source and to not illuminate the first indicia in the first marking layer in an “off” status of the first light source;
the second light source is configured to illuminate the second indicia in the second marking layer in an “on” status of the second light source and to not illuminate the second indicia in the second marking layer in an “off” status of the second light source;
the first light source is configured to be in the “off” status of the first light source when the second light source is in the “on” status of the second light source; and
the second light source is configured to be in the “off” status of the second light source when the first light source is in the “on” status of the first light source.

43. The handheld gaming controller of claim 38, wherein the first light source emits light that is colored, and wherein the first marking layer is tinted in a first-marking-layer color that is substantially the same color as the light emitted from the first light source.

44. The handheld gaming controller of claim 38, wherein the first marking layer includes texturing configured to scatter light emitted by the first light source.

45. A handheld gaming controller comprising:
a handle; and
a user input device on the handle;
wherein the user input device comprises:
first indicia in a first marking layer indicating a first function of the user input device, wherein the first indicia is configured to be illuminated by a first light source conveying light emitted through a first channel to the first indicia in response to the first light source being selectively activated in response to the handheld gaming device being configured for a first game; and
second indicia in a second marking layer indicating a second function of the user input device, wherein the second indicia is configured to be illuminated by a second light source conveying light emitted through a second channel to the second indicia in response to the second light source being selectively activated in response to the handheld gaming device being configured for a second game, the second game being different from the first game.

46. The handheld gaming controller of claim 45, wherein the user input device comprises a button, an analog stick, a touchscreen, a touch pad, a knob, a slider, a switch, a wheel, a dial, or a directional pad.

47. The handheld gaming controller of claim 45, wherein the user input device further comprises a top casing, the first marking layer being between the top casing and the second marking layer, the top casing configured to allow the first indicia to be visible to a user through the top casing when the first indicia is illuminated by the first light source, the top casing further configured to allow the second indicia to be visible to the user through the top casing when the second indicia is illuminated by the second light source.

48. The handheld gaming controller of claim 45, wherein the user input device further comprises a substantially opaque base layer, the second marking layer being between the base layer and the first marking layer.

49. The handheld gaming controller of claim 45, wherein the first light source emits light that is colored, and wherein the first marking layer is tinted in a first-marking-layer color that is substantially the same color as the light emitted from the first light source.

50. The handheld gaming controller of claim 45, wherein the first marking layer includes texturing configured to scatter light emitted by the first light source.
